(19) United States
(12) Patent Application Publication
(10) Pub. No.: US 2002/0010593 A1
(43) Pub. Date: Jan. 24, 2002

(54) Electronic reading system with e-commerce capabilities

(76) Inventor: Henry C. Yuen, Pasadena, CA (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 09/873,802

(22) Filed: Jun. 4, 2001

Related U.S. Application Data
(60) Provisional application No. 60/209,114, filed on Jun. 2, 2000.

(51) Int. Cl. G06F 17/60

(52) U.S. Cl. 705/1

(57) ABSTRACT

In an electronic-book or general-purpose computing environment, such data are downloaded as may be needed to locally conduct e-commerce transactions. The information needed to complete the transactions is then automatically forwarded to a central server or other remote location(s) for final steps of sale or other fulfillment. The downloading and forwarding may be done automatically, by downloading certain catalog information upon connection, and automatically forwarding certain response information upon detecting the existence of a response. Alternatively, the downloading and forwarding may be accomplished the next time communication is established, or selectively (as selected by the user after establishing communication), or by a prompt and response; that is, by prompting the consumer to approve sending of the response to the server. Although the invention is described with reference to an electronic book, the approach is applicable to non-general and general-purpose computing devices, including pen-based computers and PDAs.

### REFERENCE TO RELATED APPLICATION

This application claims priority from U.S. provisional patent application Serial No. 60/209,114, filed Jun. 2, 2000, the entire contents of which are incorporated herein by reference.

### FIELD OF THE INVENTION

The present invention relates generally to electronic books. More particularly, the invention relates to an electronic book, magazine or other form of reading system having form-download capabilities for added functionality.

### BACKGROUND OF THE INVENTION

Electronic books are becoming a technological and economical reality. However, electronic books or e-books continue to be compared with conventional books on factors such as readability and weight, thereby slowing acceptance. Other concerns include problems associated with connecting to on-line services to receive downloads.

Inventions directed to electronic book technology date back to the 1970s. According to U.S. Pat. No. 4,159,417, the contents of a book, magazine or the like, are digitally encoded onto a memory, and the memory is removably insertable into a portable book-like apparatus whereby the encoded information can be displayed on a screen of the apparatus. Although the specific embodiment described is a holographic memory system, this patent also contemplates the use of other digital, nonvolatile memories, including microfilm, graphically encoded cards or discs, magnetic-bubble memories, as well as other optical or electronic media.

Over the last two decades, numerous other patents have been awarded which describe improvements in fundamental ebook technology, including advances in data communications and human interaction. U.S. Pat. No. 5,534,888 describes a hinged, book-like housing with electronics including a processor for manipulating data, a memory for data storage, an input for entering data, and an output for removing data. A plurality of display pages are provided which may be turned for a continual flow of data, text, video, and graphics.

When the ebook is closed, however, certain electronic functions may remain active, thereby providing a user with a variety of communications accessories, including a paging system. For example, the plurality of displays may be read, as well as scrolled using a plurality of finction keys, to identify textual materials such as incoming pages, cataloging or storing received paging messages, titles stored materials, and the like. The central processor is also networked, so that data or information can be downloaded or uploaded between a network using a variety of methods such as a direct electrical connection, a wireless link having a radio receiver and a radio transmitter for paging and cellar communications, or the like.

Although the electronic book described in U.S. Pat. No. 5,534,888 is provided with certain communications features, both the disclosed hardware and attendant functionality are limited in scope. Due to the fact that the cost of communication is high, and the fact that eBooks do not have general computing capabilities such as full html browsing, the need remains, for an ebook having more advanced communications capabilities. In particular, there is a need for eBook which enables consumers to purchase goods or services using the device, including the purchases of books to be read on the device, as well as other products. Such advances would hopefully defeat comparisons with conventional books and justify the higher upfront investment required for the ebook.

### SUMMARY OF THE INVENTION

This invention is directed to making e-commerce communications cost effective and straightforward to execute within an electronic-book environment. Broadly, according to the invention, such data are downloaded as may be needed for the device to locally conduct e-commerce transactions, and then information needed to complete the transactions automatically is forwarded to a central server for final steps of sale and fulfillment.

The downloading and forwarding to the central server may be carried out in various ways according to the invention. For example, it may be done automatically, by downloading certain catalog information upon connection, and automatically forwarding certain response information upon detecting the existence of a response. Alternatively, the downloading and forwarding may be accomplished the next time communication is established, or selectively (as selected by the user after establishing communication), or by a prompt and response; that is, by prompting the consumer to approve sending of the response to the server.

Although the invention is described with reference to an electronic book, the approach is applicable to non-general and general-purpose computing devices, including pen-based computers and PDAs. The invention is further applicable to configurations which include local wired or wireless links, as well as wide area networks. In addition to a “store-and-forward” mode of operation, more sophisticated selective mechanisms may be used for downloading, based, for example, on cumulative buying habit, demographics and other external information.

### DETAILED DESCRIPTION OF THE INVENTION

This invention facilitates commercial transactions within an ebook environment by limiting the need for continuous on-line communications. The details are provided first as an example, then extended to various situations.

The example used will be that of an ebook which downloads an electronic catalog. In this instance, ‘catalog’ may be defined as a set of data which presents information on certain goods or services to which a user may respond on specific selections of interest by providing information on the selected product or service, (i.e, how many, which size, when to reserve) as well as information about the consumer (i.e., name, address, credit card or other information).

The collection of this information is achieved by utilizing the information downloaded and locally interacting with the consumer. Then the information is essentially “stored and forwarded” to a central server. The downloading and forwarding to the central server may be carried out in various ways according to the invention. For example, it may be done automatically, by downloading certain catalog information upon connection, and automatically forwarding certain response information upon detecting the existence of a response. Alternatively, the downloading and forwarding may be accomplished the next time communication is established, or selectively (as selected by the user after establishing communication), or by a prompt and response; that is, by prompting the consumer to approve sending of the response to the server.

The downloading of the information may further be subject to a smart-agent selection process which chooses those catalog information that may be most suitable for a particular consumer, time, or other circumstances, either cumulatively or circumstantially or a combination of both (based on history, current environment or a combination of these and other factors which may influence effectiveness or desirability of the catalog to the user or class or users).

In addition to the embodiments just described, it will be apparent to those of skill that the invention may be extended in various ways. For example the invention may be extended to devices beyond eBooks which may be any non-general purpose computing devices, including pen-based computers and PDAs. The invention is further applicable to configurations which include local wired or wireless links, as well as wide area networks.

The invention is additionally applicable to information which may be beyond e-commerce or catalog, but which can tolerate the level of non-time-urgency that a “store and forward” system can support. More sophisticated selective mechanisms may be used for downloading, based, for example, on cumulative buying habit, demographics and other external information. A system according to the invention may further include a reminder finction which would prompt the user to connect based on passage of time or the type of orders placed or a combination of above as well as other factors.

I claim:

1. A method of improving the ability to conduct electronic commerce transactions using an e-book, comprising the steps of:
downloading information to the e-book enabling a user of the e-book to locally conduct a portion of an e-commerce transaction; and
completing the transaction at a location remote from the e-book.

2. The method of claim 1, wherein the operations associated with completing the transaction include the fulfillment of a purchase of goods.
